(19) United States
(12) Patent Application Publication
(10) Pub. No.: US 2012/0012440 A1
(43) Pub. Date: Jan. 19, 2012

(54) NEGATIVE-PRESSURE CONVEYOR

(76) Inventors: Marcus Gasser, Bietigheim-Bissingen (DE); Wolfgang Pfeiffer, Stuttgart (DE); Mario Hirsch, Calw (DE)

(21) Appl. No.: 13/185,834

(22) Filed: Jul. 19, 2011

(30) Foreign Application Priority Data
Jul. 19, 2010 (DE) 10 2010 032 334.9

(51) Int. Cl. B65G 17/46

(52) U.S. Cl. 198/689.1

(57) ABSTRACT

The invention relates to a device for transporting sheet-like products having an edge comprising a negative-pressure unit having a longitudinally running intake opening. Air can be taken in through the longitudinally running intake opening, wherein a row of the sheet-like products can be attached to the longitudinally running intake opening via their edges. The edges lie against said longitudinally running intake opening and extend transversely to the longitudinally running intake opening while being transported.

### BACKGROUND OF THE INVENTION

The present invention relates to a device for transporting sheet-like products which have an edge at least over a certain portion.

Sheet-like products which have at least one edge running over a certain portion may be understood to mean, for example, printed products, cartons, blanks, folding boxes, panels, newspapers, brochures or catalogues, packs, envelopes, etc. All of these products have in common the fact that they are of sheet-like design, wherein sheet-like here need not necessarily mean planar; the products may also be curved or corrugated, but have an edge which runs in a defined manner over a certain portion. Such products are discharged as a stream of products usually from a preceding station, for example a printing device, a folding device, a punching device or, in the case of envelopes, an envelope-filling installation.

For further handling purposes, the intension is for this stream to be sub-divided into individual units and for these units to be transferred, for example, into a container or the like.

It is also possible for strapping or packaging operations to take place downstream; the critical factor is that a certain quantity or batch size has to be moved.

In the case of envelopes, certain data, for example zip-code areas, are used in order for these envelopes to be separated out of a continuous stream, and transferred into corresponding transporting containers, to date still by hand.

In the case of other products, for example folding boxes, blanks, once punched out, are adhesively bonded to give a preform, although the latter is still sheet-like, rather than three-dimensional.

These blanks are then transferred, for example in batch sizes of several hundreds, to a filling station.

Taking a toothpaste pack as an example, this box, produced as a punched sheet, is adhesively bonded over a longitudinal edge and transported further to the filling means as an as yet more or less two-dimensional sheet-like product. At the filling station, the sheet-like product is then erected to form a three-dimensional body, and filled, by a toothpaste tube being pushed in, and the container is closed at the top and bottom ends.

In practice, such prefabricated boxes are supplied, for example in batch sizes of approximately 250 packs, in the form of a horizontally extending stack. The operator takes hold of such a stack, which may well have a length of up to one metre and weighs a number of kilograms, places his hands at both lateral ends, presses the stack together somewhat, raises it up from the transporting device and transfers this stack into a container.

This method of transportation is not just very laborious; in addition, in particular when the operator gets tired after a few hours, such a stack can slide away if there is no longer sufficient force present in order to press the stack together from the outside.

This then means that for example 250 individual sheet-like products which have fallen down have to be collected up and sorted correspondingly, in particular when they are then subsequently fed for further processing, for which a certain orientation is required.

This is very work-intensive and time-consuming and interrupts the transporting operation for a relatively long period of time.

It is therefore an object of the present invention to remedy this and to provide a device for transporting a row of such sheet-like products and in the case of which this operation can be automated.

### SUMMARY OF THE INVENTION

This object is achieved by a device for transporting sheet-like products in a transporting direction, said sheet-like products having an edge at least over a certain circumferential portion, said device comprising a negative-pressure unit having an underside and a longitudinally running intake opening on said underside, wherein air can be taken in through said longitudinally running intake opening via a negative-pressure source, said air intake causing a negative pressure generating a suction, wherein a row of said sheet-like products which are to be transported can be attached to said longitudinally running intake opening by said suction, and wherein said row of said sheet-like products is hanging on said intake opening via said edges and said edges extend transversely to said longitudinally running intake opening while said products being transported by said device along said transporting direction.

It has been surprisingly shown in numerous tests that it is possible for a row of such sheet-like products which are to be transported, and have an edge which runs in a defined manner over a certain circumferential portion, to be attached to such a negative-pressure unit, to be precise such that the defined edge of these products extends transversely to the longitudinally running intake opening.

Although the individual edges of a sheet-like product provide a relatively small engagement surface area, it has been shown that a row of such products can nevertheless be positioned in a very firmly adhering manner on an intake opening, and therefore they hang on the underside of the negative-pressure unit.

It has been shown here that, by means of the negative-pressure source, air which is present in or between the sheet-like products is, in the first instance, extracted by suction, which makes it possible for the sheet-like products to be lined up very close together. This means that the edges are then located relatively closely one beside the other, with the same orientation, and this therefore results, as seen over a certain length portion, in a more or less closed sheet-like body which is made up of numerous product-edge portions located one beside the other. Each edge has a finite width, which is determined for example by the thickness of the material or, in the case of folding edges, by the thickness of the fold. In the abutting form, it is possible, with corresponding suction power, for a large number of such sheet-like products to be fitted in a firmly adhering manner on the negative-pressure unit. In this state, it is possible, then, for the products hanging in this way on the underside of the negative-pressure unit to be transported to some other location, for example to a container.

In a further embodiment of the invention, for this purpose, the negative-pressure unit can be moved together with the sheet-like products attached.

This measure has the advantage that the combination of the negative-pressure unit and the sheet-like products attached thereto can then be moved, for example from a transporting belt, which is supplying the row of sheet-like products, to a container in order to be transported further.

For this purpose, in a further embodiment of the invention, the negative-pressure unit is connected to a transporting unit, by means of which the negative-pressure unit can be transferred at least between a first position and a second position.

The transporting unit is made to suit the given requirements, and may comprise, for example, a pivotable transfer arm, which only transfers the negative-pressure unit; the transporting unit may then also be a unit which can be displaced in its entirety and shifts the sheet-like products to any desired remote location.

In a further embodiment of the invention, it is possible to change the size of an effective intake cross section of the intake opening.

This measure, then, has a number of advantages.

A first advantage consists in that a change in the effective intake opening makes it possible to provide for adaptation to different lengths of rows of lined-up sheet-like products. The expression “change in the effective intake opening” means that the intake cross section of the intake opening via which air can be taken in can be changed in particular along its longitudinal extent.

It is possible here to provide for adaptation to different products since, for example, 250 lined-up envelopes may have a different length to, for example, 250 abutting packs or the like provided with a relatively thick folding edge.

A further advantage is that, in the case of a certain sheet-like product, it is possible to adapt to shrinkage of the initial row length if air present between the individual sheet-like products has been extracted by suction.

For efficient and cost-effective operation, it is necessary for as little dead volume as possible to be taken in, i.e. quantities of air which can enter into the intake opening between the front and rear ends of a stack, or at either of these ends, should be as small as possible. If this dead volume can be kept to as low a level as possible, the negative-pressure conditions which form between the transversely running edges and the intake opening are such that both the individual sheet-like product and the entire row are retained firmly on the intake opening.

If, for example, on account of the geometry of the sheet-like products or the production of the latter, a relatively large quantity of air is present in the product, or between two products located one beside the other, then this air is extracted by suction via the intake opening. In this case, the length of the stack shrinks. Appropriate adaptations can be made here by virtue of the ability to change the length of the intake opening, i.e. the length of the intake opening can be shortened, and therefore, at the end of the stack, there is no region of the intake opening remaining open, through which mainly air would then be taken in.

In a further embodiment of the invention a displaceable covering is provided, by means of which sections of the intake opening can be covered and therefore the size of the intake opening can be changed.

This is a mechanically straightforward solution, for example, for adapting the length of the intake opening. It is also possible to vary the width of the intake opening.

This displaceable covering can be used not just to ensure that the size of the intake opening is adapted; introduction of the covering allows brief interruption of the adhering contact between the intake opening and the attached products, and therefore the latter then fall off. It is possible here to cover only certain regions or the intake opening as a whole.

This can be carried out in a specific manner if the products have been shifted over a container, for example, by way of the negative-pressure unit and the latter is to be moved away from the negative-pressure unit.

In a further embodiment of the invention, the negative-pressure unit is designed as a suction bar, at one end of which a suction connection is present and from the other end of which the displaceable covering can be introduced.

This measure has the advantage that, by virtue of mechanically very straightforward means, it is possible for both the intake opening to be adapted in length and for the products to be detached. This displaceable covering, however, also has a further advantage: it is possible, for example, for the covering to be pushed, in the first instance, to a very great extent into the suction bar, and therefore the intake opening is virtually completely closed or open only to a slight extent. If it is desired to fit the sheet-like products gradually on the negative-pressure unit, then it is possible for the covering to be gradually displaced and for the intake opening to increase in length in the process, and therefore gradually more and more products can be attached.

In a further embodiment of the invention, the negative-pressure unit comprises a telescopic suction bar, by means of which the length of the intake opening on the underside can be changed.

This measure has the advantage that the change in length can be carried out very straightforwardly in mechanical terms via these telescopic configurations.

In a further embodiment of the invention, the change in length can be regulated by a drive.

This measure has the advantage that this operation can be carried out fully automatically by this drive. The drive is regulated, for example, such that it frees, in the first instance, such a length region of the intake opening as is necessary for the stack. If a stack of a certain length is supplied, this is input, and therefore the drive then initially frees the intake opening over this length. As mentioned before, the stack shrinks to a greater or lesser extent by virtue of the negative pressure being applied, and therefore the length can be readjusted by a corresponding control means.

In a further embodiment of the invention, a transporting belt having at least one perforation is arranged on the intake opening, and this belt can be moved in a transporting direction along the longitudinal extent of the intake opening, and therefore the sheet-like products can be transported in a state in which they hang on the at least one perforation of the transporting belt via the edge.

This measure has the advantage that, in this configuration, it is not just possible for the sheet-like products to be attached to the intake opening via their edge; rather, the interposition of a perforated transporting belt means that these products can also be transported along the longitudinal extent of the intake opening.

This measure has the considerable advantage that the transporting device per se may then be stationary; lengthwise transportation takes place by way of the moveable, perforated transporting belt.

In a further embodiment of the invention, the intake opening has a plurality of slot openings, the at least one perforation of the transporting belt running along the same.

Providing a certain pattern of perforations in the transporting belt makes it possible to cater for the geometry of that edge of the product via which the sheet-like product is to be attached. The size and number of perforations, then, is calculated so as to establish sufficient negative pressure between the edge and the transporting belt, and therefore the sheet-like product hangs sufficiently firmly and, at the same time, can be transported by the transporting belt. On account of the fact that the perforations run along the slot openings, it is ensured that, as seen over the transporting path, suction or negative pressure is always applied through the perforations in the transporting belts, and thus also to the sheet-like product hanging on the transporting belt.

In a further embodiment of the invention, the at least one perforation of the transporting belt is formed by holes which extend as rows of holes both in the longitudinal and in the transverse directions of the intake opening and communicate with the slot openings.

This reflects the previously mentioned advantageous measure, that is to say that, as seen over the entire transporting length of the transporting belt, it is possible to provide good negative-pressure conditions which ensure that any sheet-like product hangs sufficiently firmly on the transporting belt via its edge.

In a further embodiment of the invention, the device further comprises at least one moveable slide, by means of which the sheet-like products hanging on the negative-pressure unit can be pushed away.

This measure has the advantage that the slide can be used to move the sheet-like products some way away from the intake opening, and therefore the adhering state is interrupted. The adhering products are thus released from the intake opening, or from the transporting belt, and can be transferred downwards into a container under the action of gravitational force. The slide, then, may be configured such that it accompanies, or directs, this detachment, and therefore the falling products can be transferred specifically into a container.

In a further embodiment, the slide can be brought into engagement with at least a part of the edges, e.g. upper edges, of the sheet-like products which projects laterally beyond the negative-pressure unit, thereby pushing the sheet-like products downwards away from the intake opening.

This is a particularly cost-effective and mechanically straightforward configuration in order for the products attached to the intake opening to be detached from the negative-pressure unit.

In a further embodiment of the invention, the negative-pressure unit has an interrupter, via which a negative pressure applied to the intake opening can be interrupted at least briefly.

This measure has the advantage that the previously described detachment operation is controlled by virtue of the intake power being interrupted, and therefore this detachment operation is initiated.

It is possible to combine both measures, i.e. to provide both a brief period of interruption and also, in addition, a slide, in particular when the latter also performs guiding tasks in order for the falling products to be transferred into a container in a correctly oriented state.

Of course, the features which have been mentioned above and those which have yet to be explained hereinbelow, can be used not just in the given combinations, but also in other combinations, or on their own, without departing from the scope of the present invention.

### BRIEF DESCRIPTION OF THE DRAWINGS

The invention will be described, and explained, in more detail hereinbelow with reference to a few selected exemplary embodiments and in conjunction with the drawings, in which:

FIG. 1 shows a side view of a first exemplary embodiment of a device according to the invention;

FIG. 1a shows, in highly schematic form, a plan view of the device from FIG. 1;

FIGS. 2a and 2b show schematic illustrations of a sheet-like product in the form of an envelope;

FIGS. 3a and 3b show a plan view and a side view of a first panel which can be inserted into an intake opening;

FIGS. 4a and 4b show a plan view and a side view of a second panel;

FIGS. 5a and 5b show a combination of a first and second panel;

FIG. 6 shows a plan view of a part of a perforated transporting belt with a sheet-like product hanging thereon;

FIG. 7 shows a plan view of the transporting belt from FIG. 6 located on the combination of first and second panels illustrated in FIGS. 5a and 5b;

FIGS. 8 and 8a show a schematic side view of the first exemplary embodiment of the device with additional slides, and the functioning thereof;

FIG. 9 shows a vastly simplified plan view of the device from FIG. 8 with the additional slides;

FIG. 10 shows an illustration of the negative-pressure unit according to the invention in a transporting arrangement according to the invention;

FIG. 11 shows, in highly schematic form, a side view of a second exemplary embodiment of a negative-pressure unit, in the form of a telescopic suction bar;

FIG. 12 shows a view of the telescopic suction bar from beneath, as seen in the direction of the intake opening;

FIG. 13 shows an end view of the telescopic suction bar;

FIG. 14 shows the telescopic suction bar from FIG. 11 in an operating state just prior to being inserted into a row of sheet-like products;

FIG. 15 shows a situation in which the telescopic suction bar has been inserted into a row of sheet-like products and the products are attached by suction to the intake opening via their upper edge;

FIG. 16 shows a further operating state of the telescopic suction bar, with the stack shrunk;

FIG. 17 shows an operating state of the telescopic suction bar during introduction into a container for the products;

FIG. 18 shows an operating state of the telescopic suction bar once the products have been discharged into the container;

FIG. 19 shows a third exemplary embodiment of a negative-pressure unit as seen in a bottom view of the intake opening thereof, the latter being provided with a displaceable covering; and

FIG. 20 shows an operating state of the third exemplary embodiment of the suction bar as sheet-like products are being fitted on the intake opening.

### DETAILED DESCRIPTION OF PREFERRED EMBODIMENTS

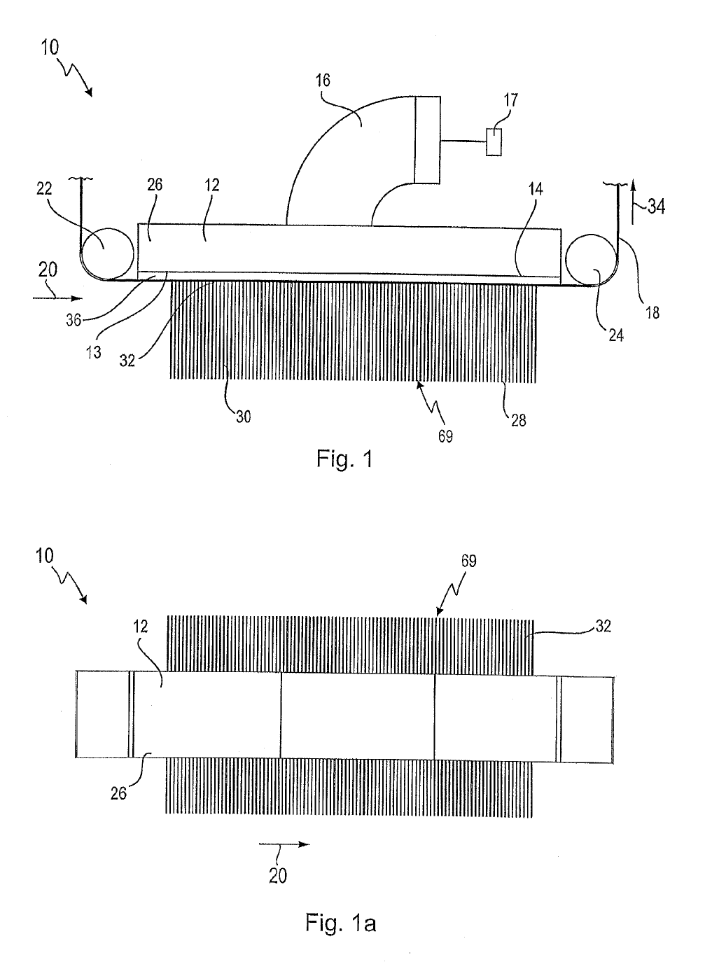

A first exemplary embodiment of a device according to the invention, this exemplary embodiment being illustrated in FIGS. 1 to 10, is designated as a whole by the reference numeral 10.

As can be seen, in particular, in FIGS. 1 and 1a, the device 10 has a negative-pressure unit 12. The negative-pressure unit 12 is designed, as seen in cross section, as an approximately U-shaped box 26, the underside 13 of which is provided with an intake opening 14. The upper end is provided with a connection 16, which connects the negative-pressure unit to a negative-pressure source 17 (not shown in more detail here).

The negative-pressure unit 12 also has a perforated transporting belt 18, which is guided in a transporting direction 20 along the longitudinal extent of the intake opening 14. The transporting belt 18 here runs over rollers 22 and 24, by means of which the transporting belt 18 is moved along the underside 13 of the negative-pressure unit 12. The transporting belt 18 is designed as an endless transporting belt.

By means of the device 10, sheet-like products 28 having a defined edge 32 at least over a certain circumferential portion are fitted in a hanging state on the transporting belt 18 by way of a negative pressure, and are transported in the transporting direction 20 by this belt.

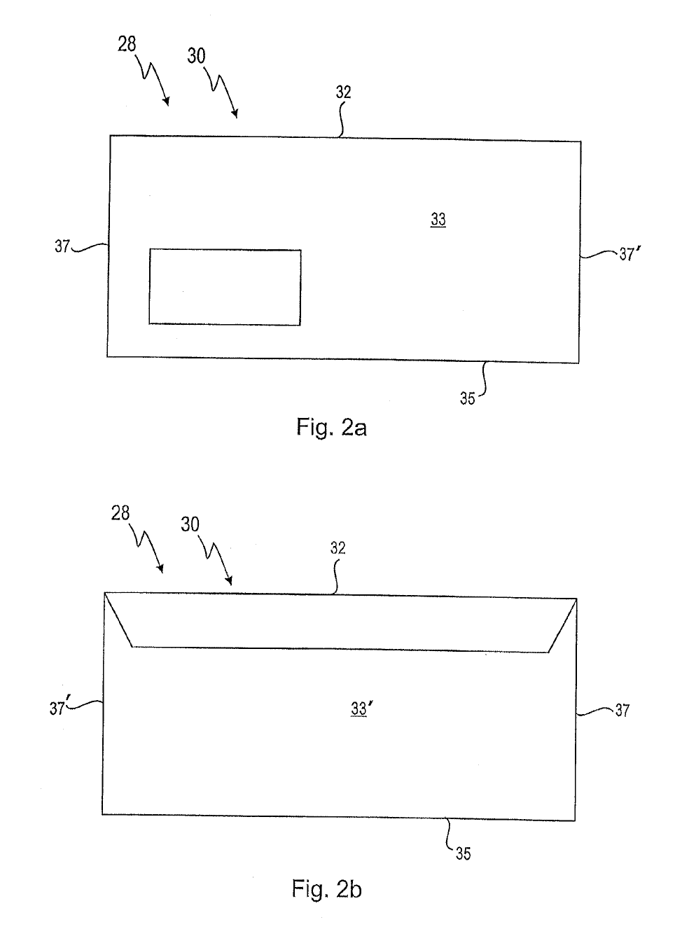

As an example of such a sheet-like product 28, FIGS. 2a and 2b show an envelope. The latter comprises a front side 33, a rear side 33′ and two side edges 37 and 37′.

Also present are an upper edge 32 and a lower edge 35, and these edges, taken together, delimit the approximately rectangular envelope 30 circumferentially.

A portion of the upper edge 32 here runs rectilinearly and therefore this envelope 30, in the position which is illustrated in FIGS. 1 and 1a, can adhere to the transporting belt 18 via this upper edge 32, and can be transported by this belt.

The arrangement of the sheet-like products on the underside 13 of the negative-pressure unit 12, i.e. on the intake opening 14, is realized, according to the invention, such that an appropriate negative pressure is applied to the intake opening 14. This negative pressure ensures a suction effect. This suction effect results in a volume flow of air entering into the intake opening 14.

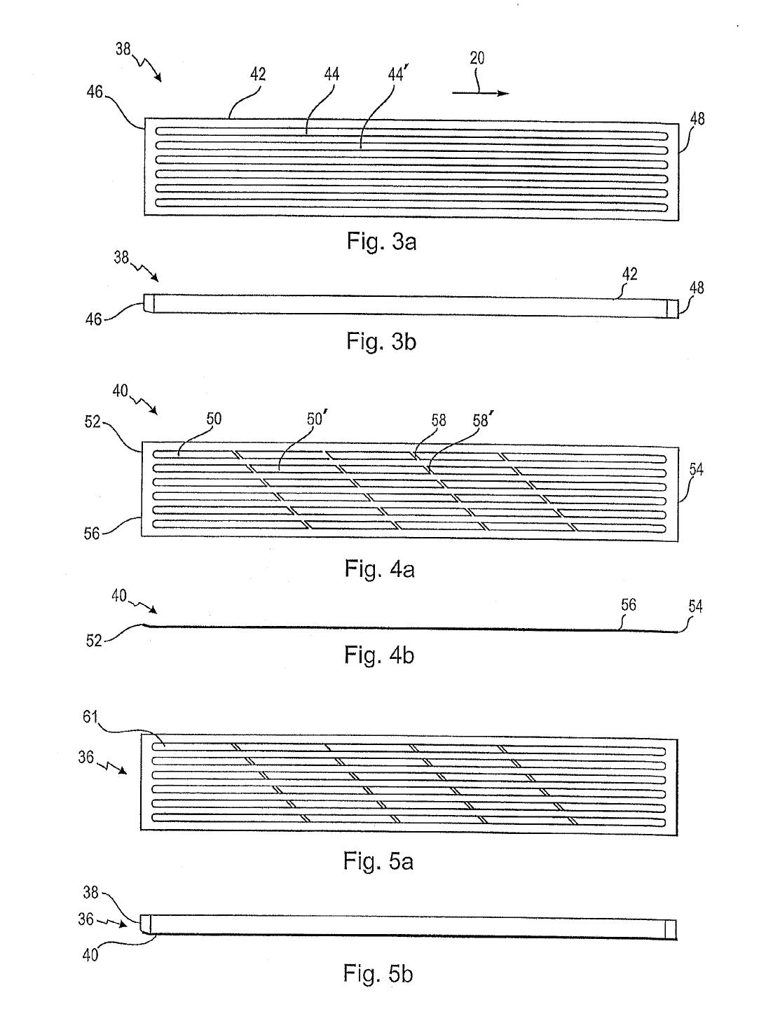

FIGS. 3 to 5 illustrate the more detailed configuration of the negative-pressure unit 12 in the region of the intake opening 14. A panel element 36, which is illustrated in FIGS. 5a and 5b, is inserted into the underside 13 of the negative-pressure unit 12. The panel element 36 has a first panel 38, as is illustrated in FIGS. 3a and 3b. It can be seen from the plan view of FIG. 3a that the first panel is made up of a rectangular basic body 42 which has a plurality of continuous slot openings 44 and 44′ extending in the transporting direction 20. The first panel 38 is closed in the region of the shorter sides 46 and 48, which are located opposite one another; this length of the sides corresponds to the width of the intake opening 14. The basic body 42 is relatively thick and, for weight-related reasons, is made of a lightweight material, for example of wood.

FIGS. 4a and 4b show a second panel 40, which is significantly thinner and is produced from a material with a smooth surface, for example a highly polished stainless steel or an appropriate plastics material. The second panel 40 also has slot openings 50 and 50′, which are designed to be congruent with the slot openings 44 and 44′. For reasons relating to stability, crosspieces 58, 58′ remain.

The short ends 52 and 54, which are located opposite one another, have the same width as the ends 46 and 48 of the first panel 38, and therefore the second panel 40 can be fitted onto the first panel 38, as is illustrated in FIGS. 5a and 5b. The second panel 40 here butts against the lower side of the first panel 38, i.e. the transporting belt 18 then runs, with a low level of friction, over this second panel 40. As can be seen from FIG. 5a, suction channels 61 which are continuous through the entire body of the panel element 36 are formed.

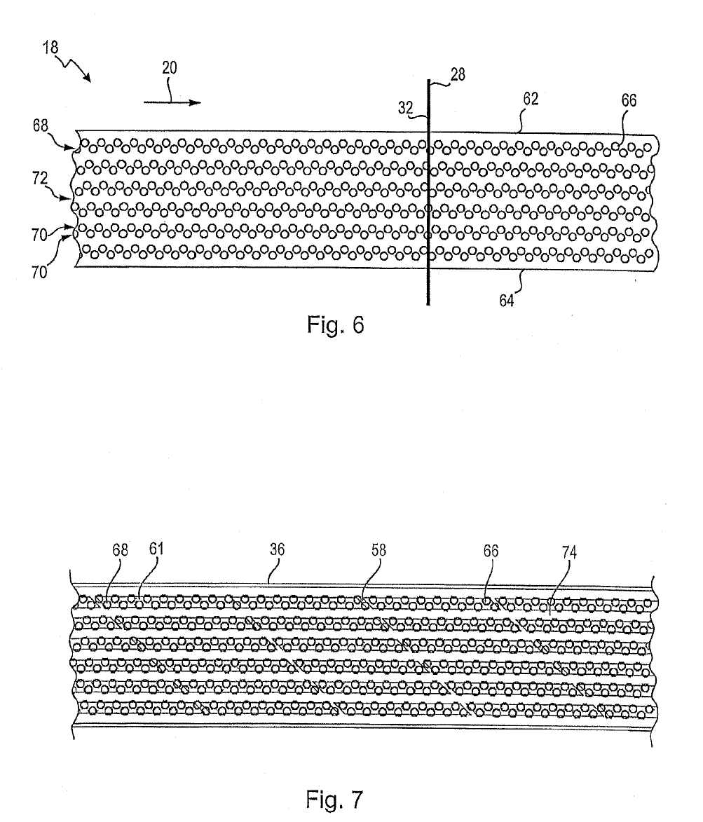

FIG. 6 shows a plan view of the transporting belt 18.

The transporting belt 18 has two opposite peripheries 62 and 64, which run parallel to the transporting direction 20. The transporting belt 18 has perforations in the form of holes 66. These round holes 66 are arranged in rows 68, wherein the five rows 68 are arranged such that they run along the channels 61 formed by the slot openings of the first and second panels.

Each row 68 here is made up of two sub-rows 70 which are staggered, i.e. the openings of one sub-row 70 are located in each case in gaps between the openings of the adjacent sub-row 70. If one imagines, as illustrated in FIG. 6, a sheet-like product 28 arranged or attached with its rectilinearly running edge 32 extending transversely to the transporting direction 20, then it can be seen that this upper edge 32 coincides with a plurality of openings 66 of the perforations, wherein the perforations provide a suction effect, that is to say the air between the upper edge 32 and the opening 66 is extracted by suction on a permanent basis.

FIG. 7 illustrates how the rows 68 of holes 66 of the transporting belt 18 can run in the transporting direction over the longitudinally running channels 61 of the panel element 36. It is thus then possible for a sheet-like product 28 hanging on the underside, as illustrated in FIGS. 1 and 1a, to be moved in the transporting direction 20.

A plurality of products 28 here are positioned in a row on the underside 13 of the negative-pressure unit 12, i.e. the intake opening 14, as can be seen in FIGS. 1 and 1a. Air between the individual products 28 is extracted by suction, and therefore these products join together to form a compact block 69, which hangs en bloc on the underside of the negative-pressure unit 12, via their numerous upper edges 32, and can be moved in the transporting direction 20 by this negative-pressure unit.

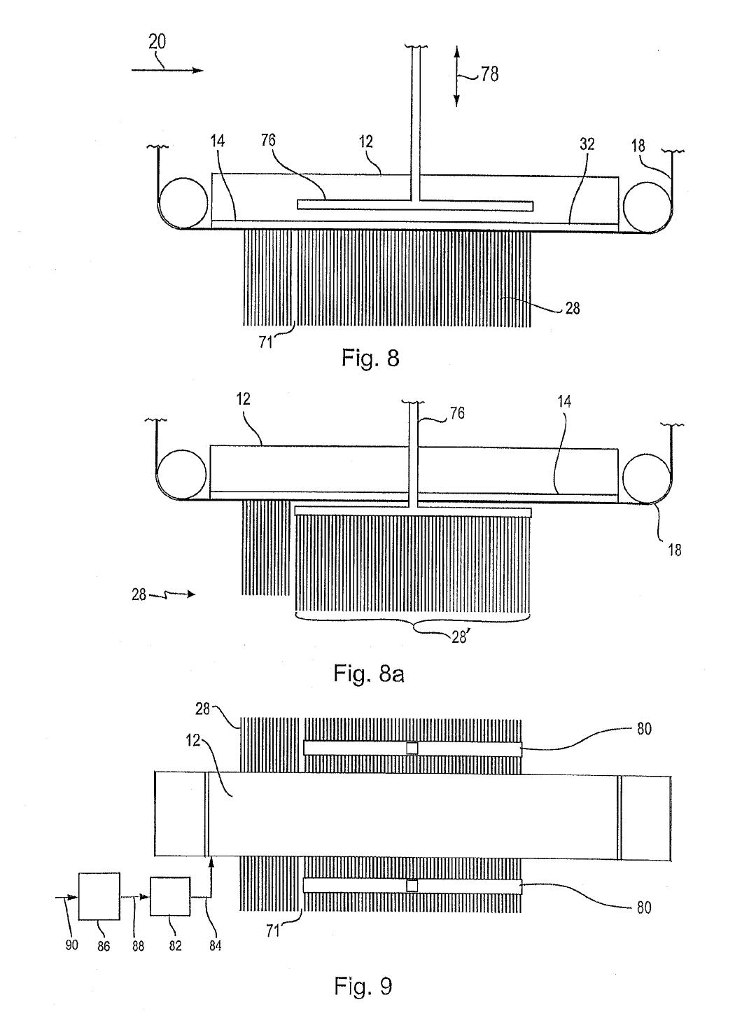

FIGS. 8 and 9 illustrate that the negative-pressure unit 12 also has a slide 76. The latter, as can be seen in FIG. 8, can be moved in the vertical direction 78, wherein, as can be seen in particular from FIGS. 8a and 9, it can come into contact with the upper edge 32 of the product 28, in particular over the portion where these products project laterally beyond the negative-pressure unit 12.

The slide 76 has two pairs 80 of slides, which can be applied, on either side of the negative-pressure unit 12, to the upper side of the block 69 and release the latter from adhering contact with the transporting belt 18 and/or the negative-pressure unit 12. FIG. 8a illustrates this, by way of example, such that the block 69 made up of the products 28′ is pushed away from the entire row of products 28. Of course, this can also take place such that the entire row or a leading portion, as seen in the transporting direction 20, is pushed away. The example depicted is intended only to explain the functional principle. FIG. 9 indicates that an interrupter 82 may also be present in the pressure unit 12. The interrupter 82 can influence the negative pressure prevailing at the intake opening 14.

In transporting mode, the interrupter 82 functions such that the negative pressure which is necessary is made available, and therefore the products 28 butt in a firmly adhering manner against the transporting belt 18. For the purpose of depositing the products 28 in a container, or transferring them into the same, a control unit 86 and corresponding signal lines 90, 88 and 84 can be used to interrupt the negative pressure briefly to the extent that the suction effect is interrupted or weakened, and therefore the products 28 fall from the transporting belt 18, for example, into a container.

This can also be coupled synchronously to the movement of the slide 76, and therefore the latter transfers the products 28 quite specifically into a container.

This can take place as the transporting belt 18 is running, or the transporting belt 18 is stopped briefly for this operation to take place, this being done via the control unit 86.

The control unit 86 can obtain data from any desired units (not described in any more detail here), as is indicated, for example, by the arrow 90. This information, for example in respect of envelopes, may be in the form of zip codes or zip-code areas, in accordance with which the envelopes are to be divided up. If, for example, a block 69 of envelopes 28′ for a certain zip-code area has been formed, the transporting belt can be moved somewhat more quickly for a brief period, and therefore a gap 71 is created in relation to the following products 28.

This block 69 can then be pushed off in a quite defined manner by the slide 76. It is then also immaterial as to whether this block 69 is of the length illustrated or shorter. The slide 76 or the pairs 80 of slides may also be designed such that it extends/they extend over the entire maximum length of a block which is to be attached. It is also possible to change the length of the pairs 80 of slides.

The negative-pressure unit 12 can be adapted in a variable manner to different products 28, that is to say to products of different widths and weights, either by the negative pressure being varied or by use being correspondingly made of other panel elements and transporting belts.

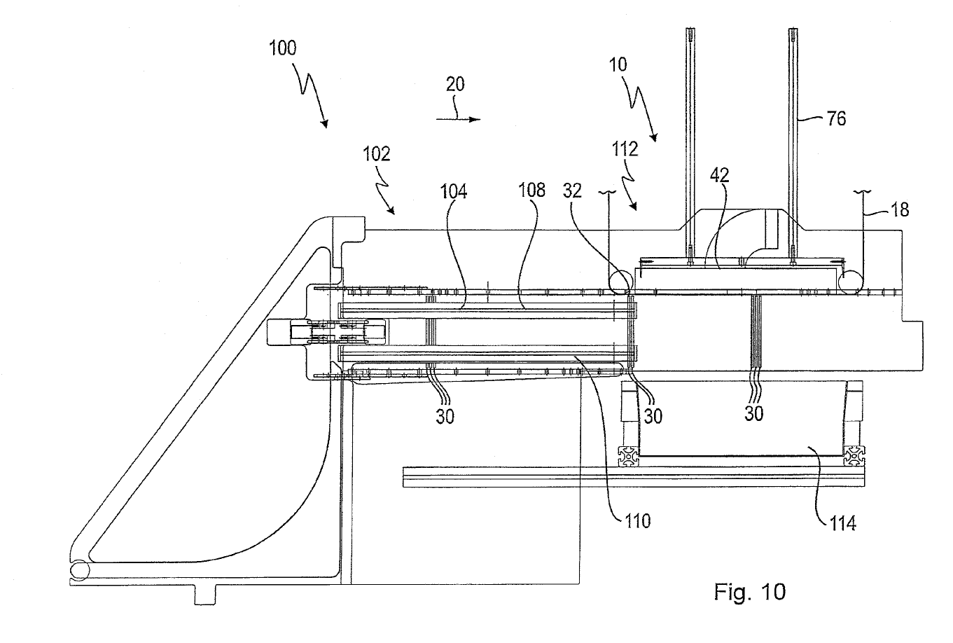

FIG. 10 illustrates an exemplary embodiment in which the device 10 according to the invention is integrated in an overall device 100. The latter has a transporting unit 102 which, for its part, has two transporting elements 104 and 106. Of these transporting elements 104 and 106, only the transporting element 104 can be seen in FIG. 10. The transporting element 104 has horizontally running transporting belts 108 and 110; the same applies to the transporting element 106 which, as one looks at the figure, is located behind the transporting element 104. The transporting belts 108 and 110 here butt against one of the upright side edges 37 and 37′ of the envelopes 30, the transporting belts of the second transporting elements 106 then butting against the corresponding edges located opposite. This means that the envelopes 30, coming from a preliminary station, are oriented in an upright state and transported in the transporting direction 20 within the transporting unit 102, in the first instance via their side edges 37, 37′, and are already being formed into a block 69 in the process. At the end of the transporting unit 102, the envelopes 30 pass into a transition region 112. From this transition region 112, the envelopes 30 are transferred into the device 10 according to the invention. In this transition region 112, the envelopes 30, in the first instance, are still retained on their side edges 37, 37′ by the transporting unit 102, but are then also gripped on their upper edge 32 by the negative-pressure unit 12. By movement of the transporting belt 18, these envelopes are then moved further in the transporting direction 20, for example they are shifted over a transporting container 114. Actuation of the slide 76 pushes the products 30 away from the negative-pressure unit and transfers them into the transporting container 114.

This can also take place, or be assisted by, the previously described interrupter 82 and/or by the control unit 86.

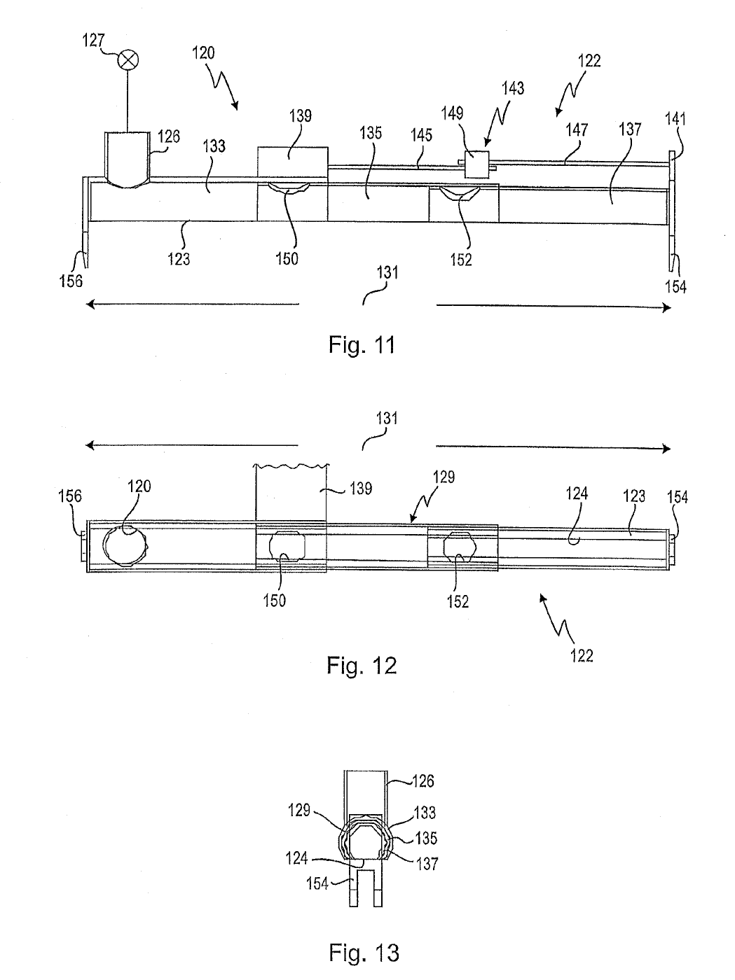

FIGS. 11 to 18 illustrate a second exemplary embodiment of a device according to the invention, which is designated as a whole by the reference numeral 120.

The negative-pressure unit 122 constitutes a significant component of the device 120. The negative-pressure unit 122 has, on its underside 123, once again a longitudinally running, approximately rectangular intake opening 124, as can also be seen from FIG. 12.

The negative-pressure unit 122 is connected to a negative-pressure source 127 via a connection 126 arranged at an end region.

The negative-pressure unit 122 has a telescopic suction bar 129, and the maximum length 131 of the latter is illustrated.

The telescopic suction bar 129 has a first telescopic bar 133, into which a second telescopic bar 135 can be introduced, wherein it is further possible for a third telescopic bar 137 to be introduced into the second telescopic bar 135.

The first telescopic bar 133 is fixed to an arm 139, via which the negative-pressure unit 122 can be moved, or pivoted, as a complete structural unit. A drive 143 is arranged between the arm 139 and the extensible end 141, this drive having two laterally offset, parallel spindles 145 and 147 which are accommodated in a common, approximately central bushing 149. By virtue of the drive 143 being actuated, the telescopic suction bar 129 can be shifted into its fully extended position 131, as is illustrated in FIGS. 11 and 12, and out of this position, as will be described hereinbelow, into a more or less retracted position. So that the drawings are not overloaded with these details, this drive is illustrated only in FIG. 11. It should be mentioned, at this point, that the telescopic suction bar 129 can also operate without the drive 143, in which case the extensible end 141 has to be moved by hand. Provision is also made for the operation of extending the telescopic bar to be assisted by a spring, and therefore the retracting operation takes place counter to the force of the spring. In order for it to be possible for the negative pressure applied by the negative-pressure source 127 to be distributed uniformly over the entire intake opening 124 in all extended positions, corresponding suction-connection openings 150, 152 are respectively provided in the second and third telescopic bars 135 and 137.

As can be seen, in particular, from the side view of FIG. 11 and the end view of FIG. 13, downwardly directed penetrating forks 154, 156 project from the opposite ends of the telescopic suction bar 129.

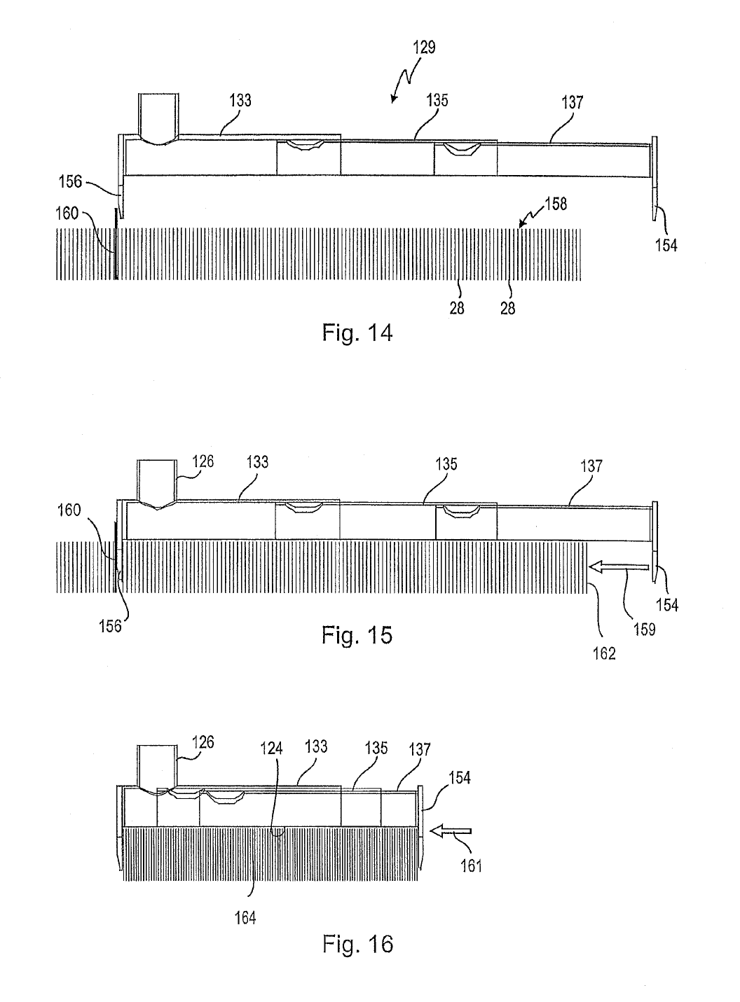

The series of FIGS. 14 to 18 will be used to describe a procedure as can be carried out using the negative-pressure unit 122 according to the invention.

It can be seen in FIG. 14 that a row 158 of upright products 28, once again envelopes in the exemplary embodiment illustrated, is supplied. A separating sheet 160 separates off a rear or trailing end of the row 158 from the next row.

The negative-pressure unit 122 is then shifted over the row 158 via the arm 139 such that the penetrating fork 156 penetrates into the row 158 from above, immediately behind the separating sheet 160, as can be seen from the transition between FIG. 14 and FIG. 15. It is illustrated here that the telescopic suction bar 129 of the negative-pressure unit 122 is extended further than the right-hand outer leading end of the row 158. By virtue of the drive (not illustrated specifically here) being actuated, the extended end 141, that is to say the penetrating fork 154, is positioned against this outer end 162 of the row 158, as is indicated by an arrow 159. The negative-pressure source 127 attaches the row 158 by suction, wherein in particular also the air between the individual products 28 of the row 158 here is extracted by suction via the approximately rectangular intake opening 124.

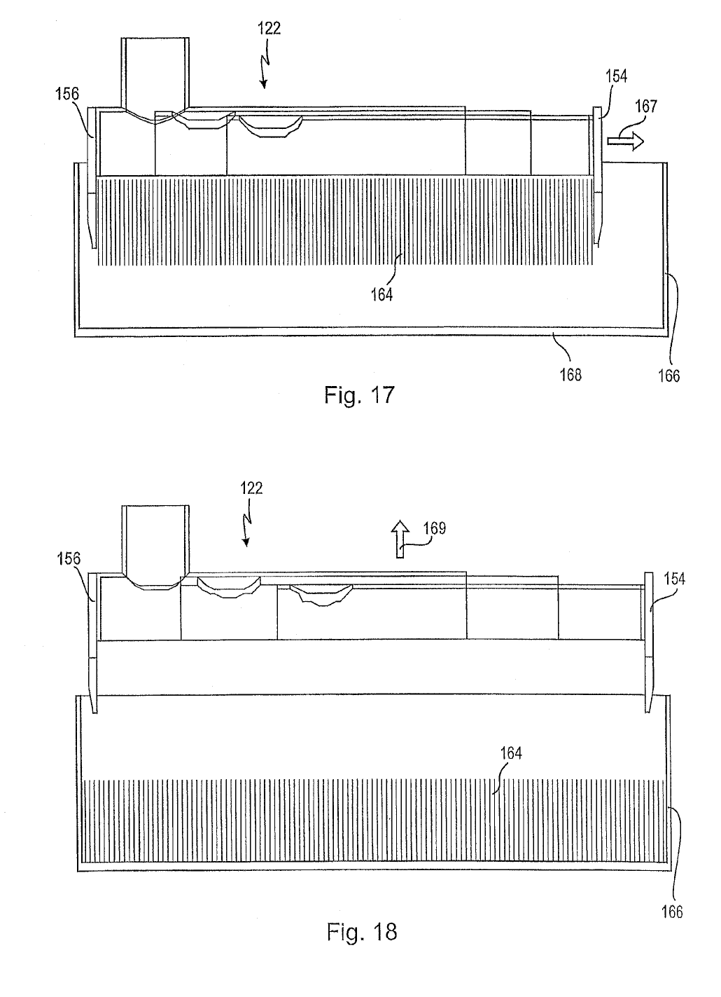

The row 158 thus shrinks to form a compressed stack 164, as is illustrated in FIG. 16. The right-hand end, that is to say the penetrating fork 154, is constantly readjusted in accordance with the stack, and thus butts under pressure against the right-hand outer end 162 of the compressed stack 164.

In this compressed state, a surface area of the upper side of the compressed stack 164 butts against the intake opening 124, fully covering the same, wherein this surface area is made up of the closely abutting upper edges 32 of the envelopes 30. An intake opening 124 of dimensions 65×2 cm gives an initial surface area of 130 cm². In the case of a negative pressure of −0.2 bar, it is possible to attach a load of approximately 25 kg (258 N). The stack 164 is retained firmly by the negative pressure to the extent that the negative-pressure unit 122 can then be moved in its entirety, for example it can be shifted over a container 166 illustrated in FIGS. 17 and 18.

As can be seen, in particular, from FIG. 17, the negative-pressure unit 122 enters into the open end of the container 166 from above. This can be carried out until the compressed stack 164 ends up located on the base 168 of the container 166, or also such that the stack is retained at a certain distance above the base 168.

The moveable end of the telescopic suction bar 129 with the penetrating fork 154 is then extended some way, as is indicated by the arrow 167.

The compressed stack 164 then either slides, in its entirety, onto the base 168 or, if the stack is already on the base, it is possible, in this state, for the negative-pressure unit 122 to be moved away upwards, as is illustrated in FIG. 18 by the arrow 169.

The compressed stack 164 then widens somewhat, i.e. it is possible for some air to enter in between the individual products again or, in particular if these products are folded ones, the latter expand again to some extent and fill the container 166 completely.

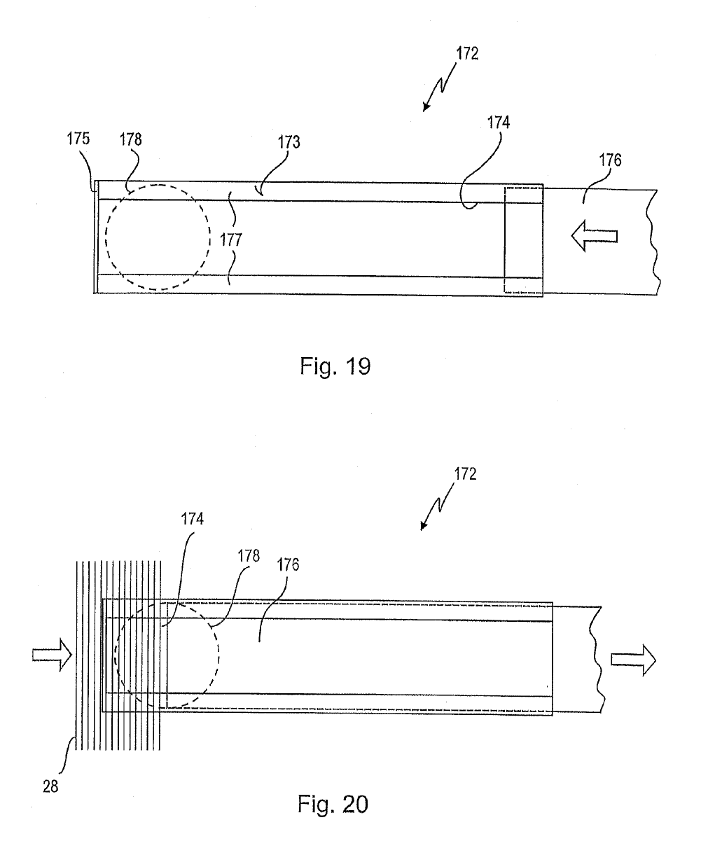

FIGS. 19 and 20 illustrate a third exemplary embodiment of a negative-pressure unit 172 according to the invention.

The negative-pressure unit 172 comprises a U-shaped hollow profile, of which the undersides of the U also each have inwardly angled peripheries 177. The resulting suction bar 175 is closed off at one end. The negative-pressure unit 172 is connected to a negative-pressure source (not illustrated specifically here) via an intake opening 178 in the upper side.

A covering 176 in the form of a sliding plate can be pushed laterally into the interior of the suction bar 175, as is illustrated in FIG. 17 by an arrow. The covering 176 here rests on the inwardly projecting peripheries 177.

The effective cross section of the intake opening 174 is thus determined by the longitudinal edges of the peripheries 177, the termination on a left-hand side and the position of the covering 176. The further the covering 176 is pushed in, the smaller is the size or length of the intake opening 174.

The covering 176 also ensures that the suction bar 175 is closed off in an air-tight manner to the right-hand side, from which the covering 176 is pushed in.

FIG. 20 illustrates a situation in which the covering 176 is pushed very far into the suction bar 175, and therefore only a reduced, small intake opening 174 remains. It is illustrated here that already some products 28 are hanging on the intake opening 174 via their upper edge.

This can be done, then, as described previously in conjunction with FIG. 10, by the products 28 being guided appropriately onto the underside 173. The further the covering 176 is pulled out to the right, the larger is the intake opening 174 and the greater is the number of products which can be advanced accordingly. This advancing action can be achieved, for example, by a following slide, as is illustrated in FIG. 20 by the left-hand arrow, or just by a perforated transporting belt as described above. Depending on the configuration, it is then possible, while maintaining the negative pressure, for a corresponding complete stack to be transported in a state in which it hangs on the underside 173 of the negative-pressure unit 172 or to be shifted along with this negative-pressure unit to some other location. By virtue of the covering 176 being re-introduced into the interior of the negative-pressure unit 172, the intake opening 174 can be closed again from the right-hand side, with the result that products 28 attached in this region fall downwards, since the negative pressure is no longer maintained here.

This therefore provides a basic possibility for the products 28 attached to an underside of one of the negative-pressure units illustrated to be detached.

Rather than being pushed in in the transporting direction or longitudinal direction, as illustrated, it is possible for a covering 176 to be pushed in transversely to the transporting direction, and therefore a complete attached block can be detached more or less all at once.

In the case of the design of FIGS. 19 and 20, it is possible, by virtue of the covering 176 being pushed in bit by bit, for individual blocks to be deposited little by little in different containers.

If, for example, the negative-pressure unit 172 is relatively long and for example three blocks of certain length, each, in the case of envelopes, corresponding to a zip-code area, are attached to the underside 173, appropriate swift advancement of the covering 176 in each case can result in such a block being detached little by little and transferred into a transporting container located beneath it.

The specific exemplary embodiments of the various negative-pressure units described above may be combined in an appropriate manner, i.e. the covering 176 of the exemplary embodiment of FIGS. 19 and 20 can be moved back and forth by an appropriate drive or also by hand.

What is claimed is:

1. A device for transporting sheet-like products in a transporting direction, said sheet-like products having an edge at least over a certain circumferential portion, said device comprising:
a negative-pressure unit having an underside and a longitudinally running intake opening on said underside, wherein air can be taken in through said longitudinally running intake opening via a negative-pressure source;
said air intake causing a negative pressure generating a suction;
wherein a row of said sheet-like products which are to be transported can be attached to said longitudinally running intake opening by said suction; and
wherein said row of said sheet-like products hang on said intake opening via said edges and said edges extend transversely to said longitudinally running intake opening while said products are transported by said device along said transporting direction.

2. The device of claim 1, wherein said negative-pressure unit can be moved together with said attached sheet-like products.

3. The device of claim 1, further comprising a transporting unit;
said negative-pressure unit being connected to said transporting unit; and
wherein said negative-pressure unit can be transferred at least from a first position into a second position by said transporting unit.

4. The device of claim 1, wherein an effective intake cross section of said in-take opening is changeable in size.

5. The device of claim 4, wherein said size can be changed by a displaceable covering, said covering covering sections of said intake opening.

6. The device of claim 5, wherein said negative-pressure unit comprises a suction bar having at least two ends;
said suction bar comprising a suction connection at one of said two ends; and
wherein said displaceable covering can be introduced from the other one of said ends.

7. The device of claim 1, wherein said negative-pressure unit comprises a telescopic suction bar and said intake opening comprises a length;
wherein said length of said intake opening on said underside can be changed by said telescopic suction bar.

8. The device of claim 4, further comprising a drive, wherein said change in cross section of said intake opening can be regulated by said drive.

9. The device of claim 1, further comprising a transporting belt having at least one perforation and being arranged on said intake opening;
said intake opening having a longitudinal extent;
wherein said belt can be moved in said transporting direction along said longitudinal extent of said intake opening, and further wherein said sheet-like products can be transported in a state in which they hang on said at least one perforation of said transporting belt via said edge.

10. The device of claim 9, wherein said intake opening comprises a multiplicity of slot openings; and
wherein said at least one perforation is running along said slot openings.

11. The device of claim 10, wherein said at least one perforation of said transporting belt is formed by holes extending as rows of holes, said rows extending along and transverse to said intake opening and communicating with said slot openings.

12. The device of claim 1, further comprising at least one moveable slide, wherein said sheet-like products hanging on said negative-pressure unit can be pushed away by said slide.

13. The device of claim 12, wherein at least a part of said edges of said sheet-like products projects laterally beyond said negative-pressure unit; and
wherein said slide can be brought into engagement with said part of said edges, thereby pushing said sheet-like products downward away from said intake opening.

14. The device of claim 1, wherein said negative-pressure unit comprises an interrupter; and
wherein said negative pressure applied to said intake opening can be interrupted at least briefly via said interrupter.
